(19) United States
(12) Patent Application Publication
(10) Pub. No.: US 2020/0301396 A1
(43) Pub. Date: Sep. 24, 2020

(54) INPUT DEVICE OF MACHINE TOOL AND MACHINE TOOL

(71) Applicant: FANUC CORPORATION, Yamanashi (JP)

(72) Inventor: Yuuta SEKIKAWA, Yamanashi (JP)

(73) Assignee: FANUC CORPORATION, Yamanashi (JP)

(21) Appl. No.: 16/823,940

(22) Filed: Mar. 19, 2020

(30) Foreign Application Priority Data
Mar. 22, 2019 (JP) 2019-054838

(51) Int. Cl. G05B 19/414

(52) U.S. Cl. CPC G05B 19/414; G05B 2219/36133; G05B 2219/33099

(57) ABSTRACT

Provided is an input device of a machine tool and a machine tool that can eliminate the need for separately securing an installation location of a non-contact reader on a machine surface, thereby allowing for fewer restrictions in the machine configuration, machine structure, and machine design. Disclosed is an input device of a machine tool or machine tool that includes a non-contact reader therein. The input device includes an operation panel unit that includes: a substrate to which a key is mounted; a substrate mounting member that includes a key hole into which the key is to be inserted and disposed to be laminated on a front face side of the substrate; and a covering member that is disposed to be laminated on a front face side of the substrate mounting member so as to cover a surface of the substrate mounting member and the key, in which the non-contact reader is mounted on the substrate.

This application is based on and claims the benefit of priority from Japanese Patent Application No. 2019-054838, filed on 22 Mar. 2019, the content of which is incorporated herein by reference.

### BACKGROUND OF THE INVENTION

### Field of the Invention

The present invention relates to an input device of a machine tool, and a machine tool.

### Related Art

As is well known, in the field of machine tools, by applying the CNC (Computerized Numerical Control) technology to numerically control a movement distance, movement speed, etc. by computer, repetition of the same operation, complicated operations, etc. are highly automated.

On the other hand, some machine tools incorporate a non-contact IC tag reader and, for example, the non-contact IC tag reader reads an IC tag held by an operator who has been authorized to operate the machine tool, such as an input operation to identify this operator, a result of which an operator who has not been authorized is prevented from performing an input operation on the machine tool.

Furthermore, Japanese Unexamined Patent Application, Publication No. 2008-146175 discloses “a method of managing the parameters of each mechanical element in a machine tool composed of a plurality of mechanical elements and comprising a control device, wherein each of the mechanical elements is provided with a storage means, and the parameters unique to the mechanical elements are stored in each of the storage means together with update information relating to the date and time of updating the parameters and the adjustment information relating to the date and time of adjusting the mechanical element, and wherein the control device reads the update information and the adjustment information stored in the storage means upon startup and compares them, and in a case in which the date and time of the adjustment information is later than the date and time of the update information, it is determined that the parameter has not been updated”.

Patent Document 1: Japanese Unexamined Patent Application, Publication No. 2008-146175

### SUMMARY OF THE INVENTION

Here, the non-contact IC tag reader is unable to read information in the IC tag in a case in which metal is present between the IC tag and the reader. Therefore, generally, the IC tag reader 1 provided in the machine tool T is incorporated in a form provided separately from the input device (input panel) 2 on the surface T1 of the machine T. That is, for example, as shown in FIG. 4 (refer to FIG. 2), a CNC 3, an operation panel 4, a key 5, a rotary switch 6, a push button switch 7 and the like are separated from the input device 2 incorporated in the machine T so as to be exposed on the machine surface T1 and to be installed individually on the machine surface T1. Therefore, apart from the input device 2, it is necessary to secure the installation location (area) of the IC tag reader 1.

Furthermore, it is necessary for the IC tag reader 1 to be provided separately to possess durability to cutting fluid, etc., environmental resistance, and impact resistance so as not to break even if hitting a workpiece or a tool. Therefore, it is necessary to construct a robust structure, for example, by using a case, a cover, etc. For this reason, the IC tag reader 1 became higher in cost and larger in size, and it is still necessary to secure a large installation location.

According to an aspect of the present disclosure, an input device of a machine tool includes a non-contact reader incorporated therein.

According to another aspect of the present disclosure, a machine tool includes a non-contact reader incorporated therein.

According to one aspect of the input device of a machine tool according to the present disclosure, it is not necessary to separately secure an installation location of a non-contact reader (such as a non-contact IC tag reader) on the machine surface, thereby allowing fewer restrictions in the machine configuration, machine structure, and machine design.

In addition, by installing a non-contact IC tag reader inside the input device (a space in which environmental resistance is taken into consideration), it is not necessary to require the environmental resistance of the device, and in addition, since there is no risk of hitting a workpiece or a tool, etc., it is possible to eliminate the need to construct a robust structure as conventionally. This makes it possible to realize a cost reduction and size reduction.

According to an aspect of a machine tool of the present disclosure, by providing a non-contact reader (such as a non-contact IC tag reader) therein, operation management of the machine tool can be suitably performed, thereby enabling an efficiency enhancement of machining operation or the like.

### BRIEF DESCRIPTION OF THE DRAWINGS

FIG. 1 is an exploded perspective view showing an input device (an operation panel unit, a non-contact IC tag reader) of a machine tool according to an embodiment;

FIG. 2 is a view showing a case in which a non-contact reader is provided inside a machine tool of an embodiment;

FIG. 3 is a view showing a case in which a non-contact reader is provided inside a machine tool of an embodiment; and

FIG. 4 is a diagram showing an input device of a conventional machine tool.

### DETAILED DESCRIPTION OF THE INVENTION

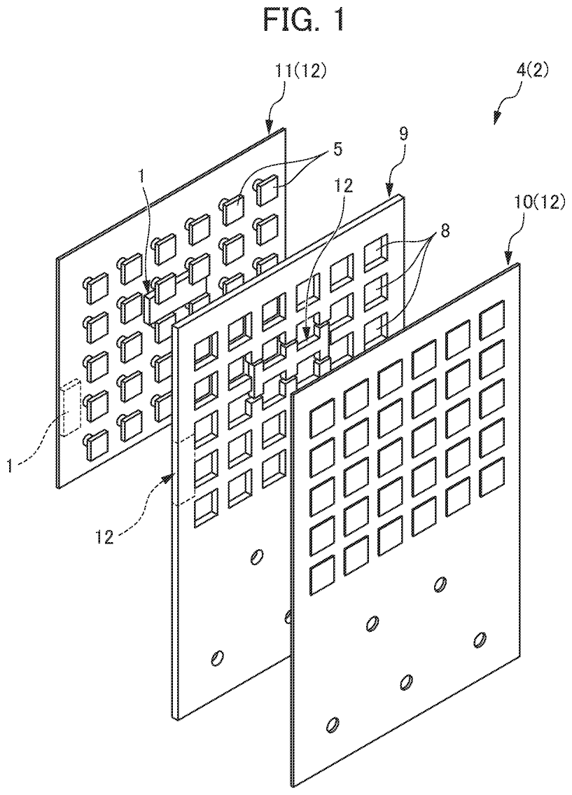

Hereinafter, with reference to FIGS. 1, 2, and 3 (and 4), a description will be given of an input device of a machine tool and a machine tool according to an embodiment.

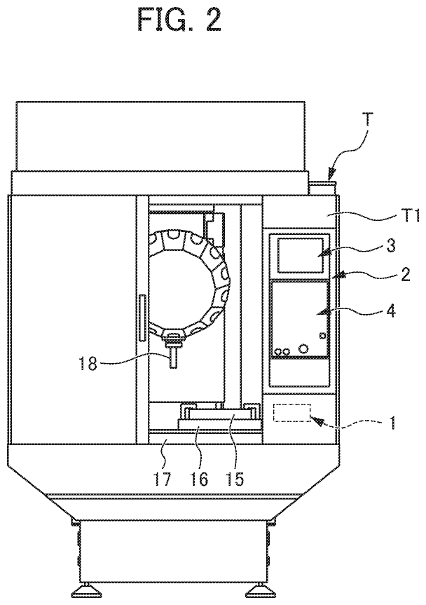

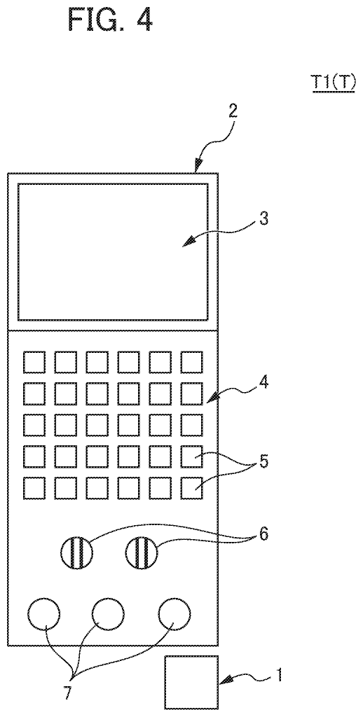

Similarly to a conventional input device, a machine tool T of the present embodiment includes, for example, an input device 2 that is provided with a CNC 3, an operation panel 4, a key 5, a rotary switch 6, a push button switch 7, etc., exposed on a machine surface T1, and that is disposed to be incorporated in the machine tool T (refer to FIGS. 2, 3, and 4). For example, the input device 2 is a device for inputting a character string to the machine tool 1 or for inputting a start signal.

As shown in FIG. 1, in the input device 2 of the machine tool of the present embodiment, the operation panel 4 (operation panel unit) includes: a printed circuit board 11 that has a rectangular plate shape in a plan view, includes a non-metallic main body, and includes a plurality of resin keys mounted thereto; a substrate mounting member 9 that has a plate shape in a plan view, includes a plurality of key holes 8 into which the plurality of keys 5 is to be inserted, respectively, and is disposed to be laminated on the front face side of the printed circuit board 11 in a manner in which the plurality of keys 5 is inserted and fit into the plurality of key holes 8 from the back face side; and a resin key sheet 10 (coating member) that has a rectangular shape in a plan view, and disposed to be laminated on the front face side of the substrate mounting member 9 in a manner covering the front surface of the substrate mounting member 9 and the plurality of keys 5.

Furthermore, a non-contact IC tag reader 1 (non-contact reader) is incorporated in the input device 2 of the machine tool of the present embodiment.

More specifically, the non-contact IC tag reader 1 of the present embodiment is mounted on the printed circuit board 11 of the operation panel 4 of the input device 2 and connected to a power supply formed on the printed circuit board 11 and wiring for communication for securing power and communication performance, and is provided to be incorporated in the operation panel 4 of the input device 2.

Although the substrate mounting member 9 of the operation panel 4 is a sheet metal, in the input device 2 of the present embodiment, at least the region of a portion where the printed circuit board 11, the substrate mounting member 9, and the key sheet 10 overlap with the non-contact IC tag reader 1 mounted on the printed circuit board 11 in the stacking direction is configured as a non-metal (for example, resin) member 12.

Furthermore, in the input device 2 of a machine tool of the present embodiment including the above-described configuration, information is exchangeable between the non-contact IC tag reader 1 incorporated in the input device 2 and the IC tag held by an operator such as a worker (operator).

Examples of the information include information of components, information of a workpiece 15, information of a tool (tool 18), information of the operator, and the like. Furthermore, it may be configured to provide a function for enabling changing the operable range by the operator, a function for associating an executed machining program with an operator, a function for saving a machining program or a machine setting by the operator, and automatically retrieving it by the operator so that the information relating to these functions can be communicated. With such a configuration, it is possible to identify and manage an executor of the machining program by, for example, allowing the operator to perform only the startup and allowing an administrator to further change a parameter. This enables the construction of a more sophisticated management system of the machine tool.

Furthermore, in the input device 2 of a machine tool according to the present embodiment, the non-contact IC tag reader 1 is provided inside the operation panel 4. This configuration eliminates the need for separately securing an installation location of the non-contact IC tag reader 1 on the machine surface T1, thereby allowing for fewer restrictions in the machine configuration, machine structure, and machine design.

By providing the non-contact IC tag reader 1 inside the input device 2 (a space in which environmental resistance is taken into consideration), it is not necessary to demand environmental resistance of the device 1, furthermore, there is no risk of hitting the workpiece 15, a tool, the jig 16, etc. Therefore, it is possible to eliminate the need to construct a robust structure as conventionally. This makes it possible to realize a cost reduction and size reduction.

In the input device 2 of a machine tool of the present embodiment, by mounting the non-contact IC tag reader 1 on the printed circuit board 11, the non-contact IC tag reader 1 is connected to a power supply, wiring for communication, etc., provided on the printed circuit board 11, and thus, the electrical power, communication performance, etc. can be easily and suitably secured.

In the input device 2 of the machine tool of the present embodiment, by making the portion of the substrate mounting member 9 overlapping with the non-contact IC tag reader 1 of the operation panel 4 in the stacking direction and the key sheet 10 with a non-metallic member (composed of a non-metallic material), it is possible to suitably ensure the communication performance with the IC tag held by an operator or the like, even if the non-contact IC tag reader 1 is incorporated in the input device 2.

Although one embodiment of the input device of the machine tool and the machine tool has been described above, the present invention is not limited to the above-described one embodiment, and can be appropriately modified within a scope not departing from the spirit thereof.

For example, in the present embodiment, although the non-contact reader is the non-contact IC tag reader 1, in a case in which the information can be exchanged in one direction or in two directions without contact, the non-contact reader may be another non-contact reader such as an RFID.

Furthermore, as shown by the broken line in FIG. 1 (reference numeral 1, reference numeral 12), the installation position of the non-contact reader 1 need not be particularly limited. Furthermore, in a case in which the non-contact reader 1 is incorporated in the input device 2, the non-contact reader 1 need not be limited to being disposed and mounted on the substrate 11, and so long as the non-contact reader 1 is disposed inside the input device 2 and information is communicable, the non-contact reader 1 may be disposed anywhere inside of the CNC 3, for example.

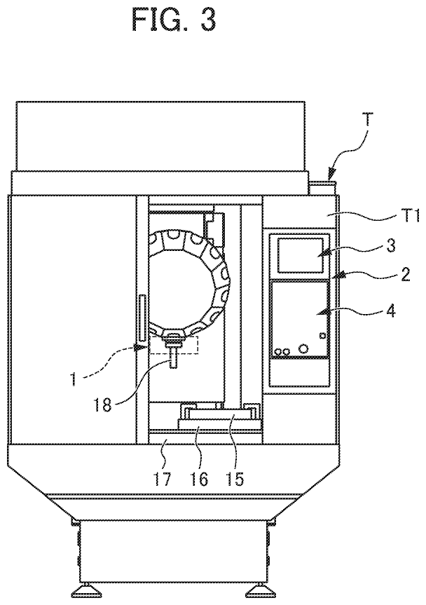

Furthermore, as shown in FIGS. 2 and 3, instead of incorporating the non-contact reader 1 into the input device 2, the non-contact reader 1 may be provided inside the machine tool 1, for example, near the table 17 as shown in FIG. 2, or near the tool 18 as shown in FIG. 3. In this case, for example, an IC tag is attached to the workpiece 15, the jig 16, the tool 18, or a replacement part, the non-contact IC tag reader 1 provided inside the machine tool T reads information of the IC tag attached to the workpiece 15, the jig 16, the tool 18, or the replacement part delivered on the table 17, thereby suitably performing operation management, equipment management, etc. This makes it possible to increase the efficiency and rationalization of machining operations, equipment management, etc. It should be noted that, in such a case of providing the non-contact reader 1 inside the machine tool T, a non-metal member (non-metallic material) is disposed around the non-contact reader 1.

### EXPLANATION OF REFERENCE NUMERALS

1 non-contact IC tag reader (non-contact reader)
2 input device
3 CNC
4 operation panel (operation panel unit)
5 key
6 rotary switch
7 push button switch
8 key hole
9 substrate mounting member
10 key sheet (covering member)
11 printed circuit board (substrate)
12 non-metallic member
15 workpiece
16 jig
17 table
18 tool
T machine tool
T1 surface

What is claimed is:

1. An input device of a machine tool, comprising a non-contact reader incorporated therein.

2. The input device of a machine tool according to claim 1, comprising an operation panel unit, wherein the operation panel unit includes:
a substrate to which a key is mounted;
a substrate mounting member that includes a key hole into which the key is to be inserted and disposed to be laminated on a front face side of the substrate; and
a covering member that is disposed to be laminated on a front face side of the substrate mounting member so as to cover a surface of the substrate mounting member and the key,
wherein the non-contact reader is mounted on the substrate.

3. The input device of a machine tool according to claim 2, wherein at least a portion of the substrate mounting member and the covering member of the operation panel unit overlapping with the non-contact reader in a stacking direction is non-metallic.

4. A machine tool comprising a non-contact reader incorporated therein.

5. The machine tool according to claim 4, wherein the non-contact reader is disposed near a table on which a workpiece is disposed.

6. The machine tool according to claim 4, wherein the non-contact reader is disposed near a tool.
